(19) United States
(12) Patent Application Publication
(10) Pub. No.: US 2013/0055601 A1
(43) Pub. Date: Mar. 7, 2013

(54) SHOWROOM DISPLAY FOR MATTRESS INCORPORATING ELECTROLUMINESCENT INKS

(71) Applicants: William D. Wright, JR., Chattanooga, TN (US); Chase McCord, Raleigh, NC (US); Peter H. Freeman, High Point, NC (US)

(72) Inventors: William D. Wright, JR., Chattanooga, TN (US); Chase McCord, Raleigh, NC (US); Peter H. Freeman, High Point, NC (US)

(73) Assignee: Wright of Thomasville, Inc.

(21) Appl. No.: 13/226,558

(22) Filed: Sep. 7, 2011

(51) Int. Cl. G09F 13/22

(52) U.S. Cl. 40/544

(57) ABSTRACT

A showroom display device for utilization with mattress foot protectors in which an electroluminescent lamp is used in conjunction with a media display panel in order to highlight or enhance the display panel or various areas thereon.

### FIELD OF THE INVENTION

The present invention relates to a showroom display device for presenting product information on showroom mattresses which utilizes electroluminescent inks to highlight or enhance areas of the information.

### BACKGROUND OF THE INVENTION

Mattresses are displayed in showrooms during the sale and distribution from the mattress manufacturer to the consumer. First of all, mattress manufacturers may display mattresses in wholesale showrooms so that retailers can get an idea of how the mattress will look in their own retail showrooms. In retail showrooms, display mattresses are arranged on the retail floor so that the prospective purchaser can peruse the various types of mattresses offered by that retailer. In each situation, marketing and/or technical features of the mattresses are communicated to the prospective purchaser via signage, labels or a personal communication between the sales representative and the prospective purchaser

Typically, display mattresses are arranged on the floor so that the prospective purchaser can peruse the various types of mattresses offered by that retailer. In addition to evaluating various promotional materials in the showroom, the prospective buyer might “test” the mattress. This “test” involves lying on the mattress to evaluate softness, firmness or other attributes desirable to the purchaser. Lying on the mattress can result in damage, soiling, wear and tear. Retail showrooms are high traffic areas, and mattresses may be repeatedly tested and damaged.

Foot protectors for mattresses have been used to minimize damage to display mattresses in retail showrooms. Protectors used to date are expensive, cumbersome to place and secure on the mattress, which may unduly damage or compromise the visual appearance of the mattress. Examples are described in U.S. Pat. Nos. 6,845,532; 6,216,292, and 6,014,782.

### SUMMARY OF THE INVENTION

The inventor has developed a unique and different way to better display product information regarding a mattress to a prospective purchaser in a mattress showroom. The display incorporates electroluminescent inks to highlight or enhance product information regarding the mattress, preferably on the foot protector.

In accordance with one aspect of the invention, the display device comprises a protective panel of such size and shape as to cover at least a portion of a surface of the mattress. The display device further includes a media display in the form of an area of programmable light emitting units associated with the flexible panel for presenting the selectively changeable visual product information. The media display is capable of having an electronic connection with a power source and the programmable product information control source.

A pattern of electroluminescent (EL) ink is arranged behind the flexible panel and is connectable to a power source. A microcontroller or other programming device activates the EL ink pattern to highlight or enhance various selected areas of the display panel at various selected times according to a prescribed program.

According to another aspect, a display pad includes a polymeric sheet of an approximate size and shape to cover at least a portion of the fabric foot protector used on the upper surface of a mattress. The display pad may be permanently affixed to the foot protector, or an adhesive material may be applied to the undersurface of the sheet that permanently adheres to the polymeric sheet, yet releasable attaches the sheet to the mattress foot protector or even onto the mattress itself, where it becomes the foot protector without marring of the surface thereof. The polymeric sheet includes product or marketing information thereon.

Again a pattern of electroluminescent ink is arranged behind the display pad and connectable to a power source. A microcontroller or other programming device activates the EL ink pattern to highlight or enhance various areas of the display panel according to a prescribed program.

In yet another aspect, the invention is the media display itself, as designed for use on or with mattress protectors.

The term “foot portion,” as used herein, means the lower inches (10-30 inches) of the upper surface of the mattress where a customer's feet would rest if the customer were to fully lie on the mattress to test the comfort and support. The term “foot protector,” as used herein, means a device used to cover at least a part of the foot portion of a mattress. The term “product information” as used herein refers to any video content, presentations, images, or any other audio, video or audio/visual content for displaying advertising materials, sales materials, manufacturer's logos and trademarks, or promotional materials arranged and/or developed for display on a media device.

The electroluminescent ink concept may also be applied behind or in front of, or even in lieu of other types of mattress foot protector displays, the idea being to utilize electroluminescent ink technology in conjunction with other product information mattress displays to present a more appealing and eye catching presentation to potential customers.

### BRIEF DESCRIPTION OF THE DRAWINGS

FIG. 1 is a perspective view of a display device placed on a mattress foot protector according to one aspect of the invention;

FIGS. 2A and 2B are plan and perspective views, respectively, of the mattress display device of FIG. 1 with the power sources and program control sources for the display pad and electroluminescent ink pattern illustrated schematically;

FIG. 3 is a sectional view of the display device taken along lines 3-3 in FIG. 2A;

FIG. 4 is a schematic representation of a typical electroluminescent ink stack that would be emplaced between the foot protector and the display pad; and

FIG. 5 is a perspective view, similar to FIG. 1, except illustrating another aspect in which the foot protector and display device are combined.

Certain exemplary embodiments of the present invention are described below and illustrated in the accompanying figures. The embodiments described are only for purposes of illustrating the present invention and should not be interpreted as limiting the scope of the invention, which, of course, is limited only by the claims below. Other embodiments of the invention, and certain modification sand improvements of the described embodiments, will occur to those skilled in the art and all such alternate embodiments, modifications, and improvements are within the scope of the present invention.

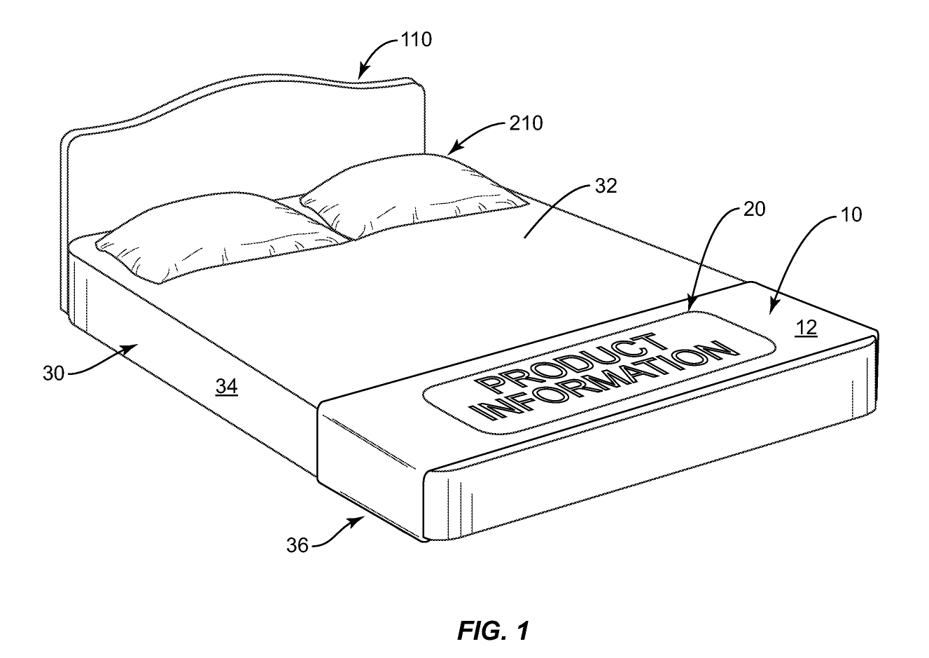

FIG. 1 shows a display device 20 which may be associated with a mattress foot protector 10 in accordance with a first aspect. The phrases “mattress showroom display device” and “media display device” are used interchangeably herein. As shown in the Figures, the media display device 20 is associated with the foot protector 10 in some manner, such as being embedded therein, or incorporated into a separate panel 12 affixed to or laid upon the various mattress components. The flexible panel 12 has a size and shape to cover at least a portion of the surface of the foot protector.

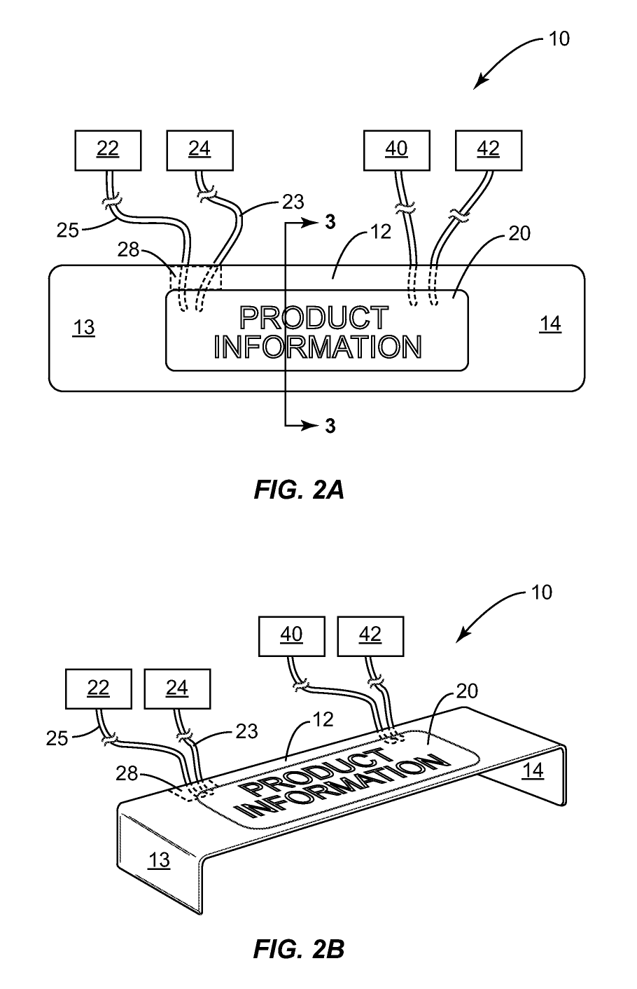

The media display device 20 is connected to a power source 22 (FIGS. 2A & 2B) to provide needed power to display the product information. The power source 22 may be a battery, connection to a conventional AC wall outlet, solar power, or other low voltage power source. The media display device is also in electronic connection and communication with a programmable product information control source 24, which provides the product information for display on the device 20 as will be further described below.

The mattress showroom display device 20 displays selectively changeable product information to a customer considering a mattress 30. As mattress products in the showroom change, or marketing programs change, product information may be developed and displayed via the media display device 20 on the corresponding mattress foot protector 10. In other embodiments, more than one media display device may be associated with a foot protector 10.

As stated previously, the media display device 20 is in electronic communication with a programmable product information source 24 to present selectively changeable product information to the customer. The programmable product information source 24 can present differing information over the same display device 20. For example, the display device 20 can be programmed to show and/or describe one type of information, then moved to a different mattress and be reprogrammed to properly show and/or describe that mattress. The programmable product information source can also change the information periodically to present differing text or media about the same mattress to the customer as he/she is inspecting or approaching the mattress. Although not shown in the figures, the media display device can also play audio signals coordinated with displayed product information, via an audio source. The audio source may be played through speakers in the media display or a separate receiver in the showroom. In other embodiments, a sensor (not shown) in the display device or mattress activates the media display device when a person approaches the mattress 30 to attract his/her attention.

According to one aspect, the media display device 20 comprises an area of programmable light emitting units embedded in the flexible fabric panel 12. The media display is embedded in one or more fabric layers, a fabric-plastic film laminate, or other combination of textile and polymeric material that forms the flexible panel 12. “Programmable light emitting units” refers to light sources that can be programmed to display the product information. For example, the media display device may include light emitting diodes, organic light emitting diodes, polymer light emitting diodes, inorganic light emitting diodes, electroluminescent materials, electroluminescent pixels or electroluminescent pixel arrays, or any light source capable of being programmed to present video and/or moving images. One example of technology that makes this possible is the Phillips Lumalive displays available from Koninklijke Phillips Electronics N.V. This technology is further described in U.S. Pat. No. 7,682,034, which is hereby incorporated by reference. In another example, the technology is flexible media displays available from NanoLumens, LLC, which is further described in U.S. Patent Application Publication No. 2009/0219225, which is also hereby incorporated by reference. In an alternate embodiment, the media display includes thin plasma and/or a thin LCD screens embedded in or placed on the flexible panel 12. Further, one or more additional light diffusing layers may be included with the light emitting units as needed.

The media display device 20 can present product information it receives from the corresponding product information source 24. As shown in FIGS. 2A and B, the product information may be received via cable and/or wire 23 from product information source 24. The product information source 24 may be a series of instructions stored in a computer memory in the display device 20, or stored in a removable computer memory. Further, product information can be received wirelessly over a communications network from the product information source 24. In such an embodiment, the foot protector 10 or flexible panel 12 may include a transmitter/antenna for receiving the wireless signal.

The instructions may then be transmitted to the media display device 20 to cause the display of the product information thereon. In other embodiments, the media display 20 may play product information in formats including, but not limited to, MPEG, JPEG, MJPEG, DVIZ, XVIS, AVI or DVD and HDDVD formats. The media display may display HD formats in 480p, 480i, 720p, 1080p, 1080i or 1086, or other formats.

The flexible panel 12 may include a wire housing 28 that begins proximate the media display device and extends toward the perimeter of the flexible panel. The wire housing 28 routes and protects various wires emanating from the media display device 20 e.g., power cords, ethernet cables, coaxial cable, A/V cables, S-video cables, HDMI wires, etc. The wire housing may be a hook and loop fastener casing, a fabric panel attached to the undersurface of the flexible panel or any other mechanism for managing and protecting wires on the panel.

In a preferred embodiment, the flexible panel 12 is a textile material including, but not limited to, a woven, knit, or non-woven material. In other embodiments, the flexible panel is a polymeric material including, but not limited to, polyvinyl chloride (PVC), polyethylene terepthalate (PET), polyethylene (PE) or polypropylene (PP). In still other embodiments, the flexible panel is a laminate of one or more layers of any combination of a textile or polymeric material.

The media display device 20 may be used with any type of mattress and mattress and/or bedding component. For example, twin, twin XL, full, queen, king, the “California king,” are exemplary sized mattresses, and associated headboards. In addition, the media display device 20 may be used on any mattress including, but not limited to, innerspring, foam (viscoelastic and/or latex), air, futons, and waterbeds.

Turning now to FIGS. 1, 2A, and 2B, a mattress foot protector 10 is releasably attached to the mattress 30, such as a display mattress in a retail showroom. The mattress foot protector 10 includes a flexible panel 12 having opposed ends 13 and 14, and a media display device 20 embedded or otherwise incorporated into or onto the panel 12. Alternatively, the media display device 20 may be incorporated onto a foot protector 10 positioned on the upper surface of the mattress 30. In yet another embodiment, the media display device 20 may be incorporated onto the mattress itself

In the embodiment shown in FIGS. 2A and 2B, a power source 22 connected to the media display 20 provides needed power to display the product information, and may be a battery, connection to a conventional AC wall outlet, solar power, or other low voltage power source as described above. The programmable product information control source 24 in electronic communication with media display device 20 provides the product information for display to a customer considering a mattress.

The foot protector 10 minimizes damage, soiling or wear to the mattress when a prospective purchaser is testing the mattress in the showroom. The mattress foot protector 10 is formed of any flexible panel 12 as described above. The foot protector may also have a decorative hem or other stitching along its perimeter to minimize fraying and to also provide a design effect. The foot protector may also include an embroidered image, design, logo or other design effect, in addition to content displayed via the media display 20.

As shown in FIG. 1, the foot protector 10 is shown having a length at least as wide as the mattress 30 so that ends 13 and 14 of the foot protector 10 may be tucked under the mattress foot portion 36 of the mattress 30 to secure the protector 10 thereto. In other embodiments, the foot protector may include a mechanical fastener and/or cordage (not shown) to secure the fool protector 10 to the mattress 30. In still other embodiments, the ends of the foot protector may include tassels and the like. While a foot protector is shown covering the side portions 34 of mattress 30, the foot protector 10 may be designed to merely rest on the upper surface 32 of the mattress 30 with or without adhesive. In other embodiments, the foot protector 10 may include more than one media display device.

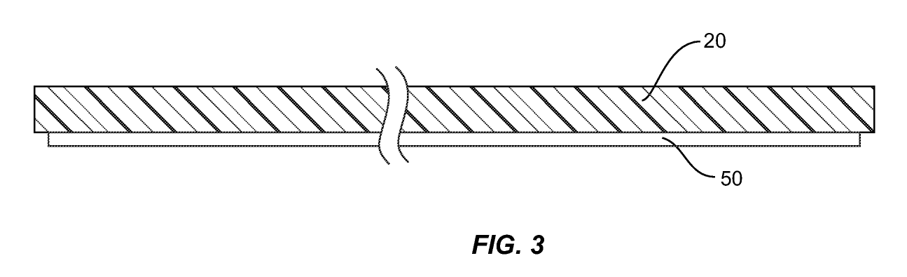

Turning now to FIG. 3, as previously discussed in accordance with the present invention an electroluminescent ink lamp is used with the foot protector 10 and display device 20 to highlight or enhance all or portions of the media display. This may occur in the form of background lighting (either continuous or flashing intermittently) of the entire media display, a portion of the media display, or even by sequentially highlighting various portions of the display in accordance with a preprogrammed pattern. The electroluminescent lamp 50 is provided in the form of an EL “stack”, which means a sandwich or plurality of layers of materials to be discussed hereinafter. In FIG. 3 the El stack or lamp 50 is preferably positioned behind the display device 20. While the term “stack” is used, it will generally take form as a film formed of several very thin ink layers, connected to a power source and programming device.

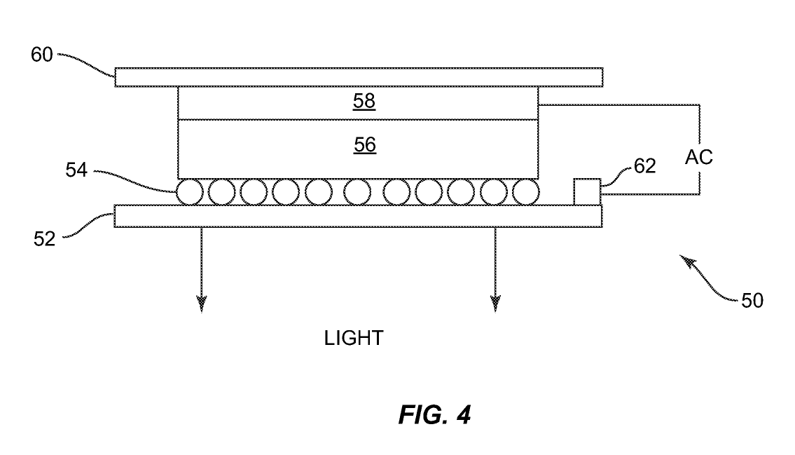

FIG. 4 is illustrative of such a stack 50 which is built as hereinafter described. First is the selection of the translucent conductive electrode or layer 52 (front electrode) which serve the purpose of being one of the electrodes, but must be transparent or translucent to allow for the passage of light. The layer may be either ITO (induim tin oxide) or some other type of translucent conductive ink on a polyester carrier, such as DuPont's Product 7162E. Layer 52 may be completely translucent which would allow for the passage of light at all times the stack is conducting. Alternatively the layer could have opaque patterning thereon whereby light passes only through a portion of the layer when activated (conducting). This and each ensuing layer must be dried and cured before proceeding to the next.

In an alternate method the order of the layers may be reversed with the rear electrode first layered onto a compatible substrate, followed by the dielectric layer, the phosphor layer, the translucent conductor (front electrode or ITO), then the clear encapsulate.

The next layer 54 is phosphor containing ink which is the constituent that servers to emit light when current is driven through it. It may be white or is also available in a limited number of colors. Exemplary phosphor inks are DuPont's 7138J (white), 7151J (green-blue), and 7154J (yellow-green). Layer 56 is a dielectric layer which acts as a series capacitor. DuPont Product 7153E is an appropriate ink product for the purposes of the dielectric. Layer 58 is the rear electrode, the purpose of which is to evenly distribute the AC voltage across the dielectric. This rear electrode is opaque, and exemplary DuPont inks include 7144E (carbon conductor) and 7145L (silver conductor). The final layer 60 is a screen printable UV cure ink, which is used as an encapsulent to provide electrical insulation and extra protection against humid environments. An extra layer (not shown) can be provided for more effective insulation. DuPont's 5018 ink is an example. As previously stated, each layer must be applied, dried, and cured before commencing the next layer.

The last step is the formation of the bus bar 62 along the edge of the front electrode 52 which provides an AC electrical potential (approximately 100 volts) to the translucent conductive layer.

The EL lamp 50 then is essentially a capacitor structure with phosphor sandwiched between the electrodes 52, 58. When an AC voltage is applied across the electrodes, a changing electric field is generated within the phosphor, which causes it to emit light. Power can be supplied in a number of ways to provide a low-current AC voltage. Returning to FIGS. 2A, 2B AC voltage is applied from power source 40, and the programmer 42. Power source 40 and programmer 42 can obviously be combined with power source 22 and programmer 24, if desired.

Such an electroluminescent lamp can be used with the display device 20 in various ways. First, utilizing a constant light across the entire display except for masked portions will provide continuous background lighting. By using an intermittent voltage signal, a flashing background light can be applied. If the electroluminescent stack or lamp 50 is built with separate conductors leading to various discrete segments of the EL pattern, by using the controller, various portions of the display can be highlighted at various times by adjusting the program. Other patterns are also possible.

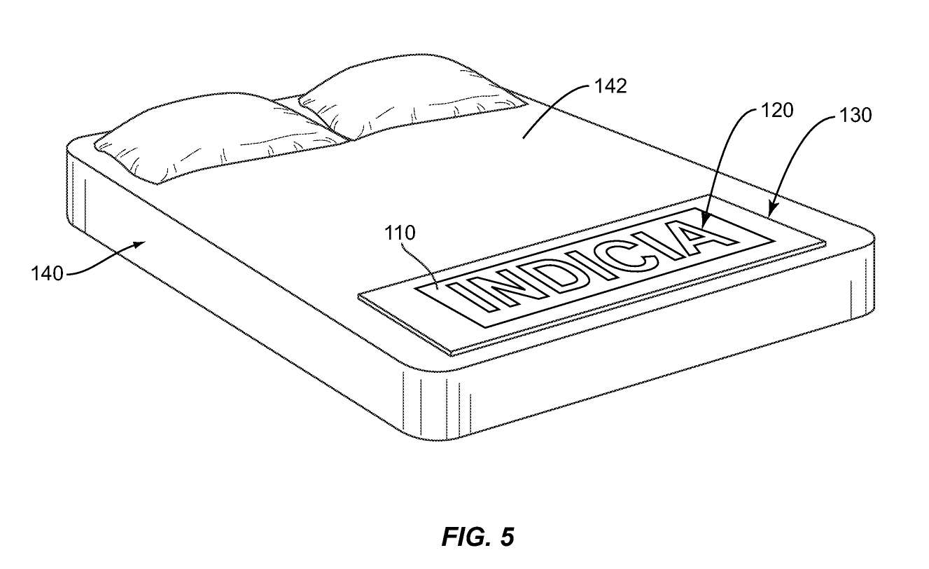

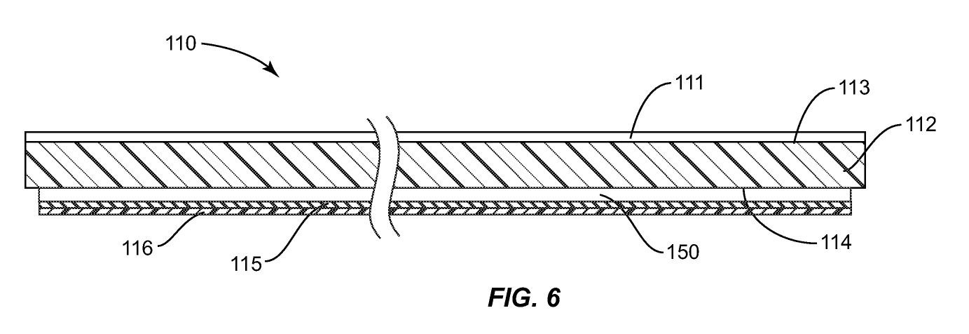

As shown now in FIGS. 5 and 6, a removable display pad 110 is releasably attached to a foot protector 130 which, in turn, is place on or attached to the mattress 140, such as a display mattress in a retail showroom. The removable display pad 110 includes a polymeric base sheet 112 carrying marketing information 120, a first or protective film 111 in the form of a transparent polymeric overlaminate on top of the base sheet 112, an electroluminescent lamp 150 attached to the underside of base sheet 112, adhesive material 115 on the underside of EL 150, and a removable film layer, or liner 116.

The removable display pad 110 displays marketing information to a customer considering a mattress and is changeable as will be discussed below. Further, the display pad 110 and foot protector 130 minimize damage, soiling or wear to the mattress when a prospective purchaser is testing the mattress in the showroom. The adhesive material is so selected as to prevent damage to the fabric when the display pad 110 is removed therefrom.

The releasability of the pad 110 allows a sales associate to easily change the marketing information 120 viewable by a prospective purchaser as needed. For example, as mattress products in the showroom change, or marketing programs change, a new display pad 110 may be used on the mattress foot protector. To accomplish this, all that is necessary is to remove the peel off liner, protective layer, or film 16 from the adhesive material 115 and place the display pad 110 on the desired foot protector.

Referring again to FIG. 5, the display pad 110 is used on a foot protector 130 secured to a mattress 140. The display pad 110 may be used with any type of foot protector 130. Further, the particular foot protector 130 may be formed of any textile material including, but not limited to, woven, knit, non-woven, or any other material, or combination of materials suitable for use as a foot protector. In a preferred embodiment, the foot protector 130 is a fabric type foot protector. The foot protector 130 may have a decorative hem or other stitching along its perimeter to minimize fraying and to also provide a design effect. The foot protector 130 may also include an embroidered image, design, logo or other design effect. The foot protector 130 is shown having a length at least as wide as the mattress 140 so that ends of the foot protector 130 may be tucked under the mattress 140 to secure the protector thereto. In other embodiments, the foot protector 130 includes a mechanical fastener and/or cordage to secure the foot protector 130 to the mattress 140. The display pad may even serve as the foot protector itself. In still other embodiments, the ends of the foot protector may include tassels and the like.

As shown in FIG. 6, the removable display pad 110 includes the polymeric base sheet 112 having top and bottom surfaces 113 and 114, respectively. The polymeric base sheet 112 may be flexible to conform to the outer surface 142 of the mattress 140 or it may be a stiffer material. In other alternate embodiments, the polymeric sheet 112 may be malleable. An exemplary polymeric sheet 112 is polyvinyl chloride (PVC). In other alternate embodiments, however, the polymeric sheet 112 may be polyethylene terepthalate (PET), polyethylene (PE) or polypropylene (PP). An exemplary polymeric sheet 112 has a thickness between about 2.0 and about 5.0 mils, preferably about 3.7 mils.

The first or protective film (or overlaminate) 111 may be any transparent polymeric film for protecting the top surface 113 of the base sheet 112. The overlaminate 111 also includes an adhesive for permanent attachment to the polymeric sheet 112. Alternatively, the overlaminate may be applied by heat and pressure, or any other technique, to the base sheet 112. Exemplary overlaminates include, but are not limited to, polyvinyl chloride (PVC), polyethylene terepthalate (PET), polyethylene (PE) or polypropylene (PP).

Marketing information 120 is included on the upper surface of the display pad 110 for viewing by a prospective customer. The overlaminate 111 is affixed to the top surface of polymeric sheet 112 to protect the marketing information 120. The marketing information 120 is printed or otherwise applied directly to the polymeric sheet 112. In an exemplary embodiment, the marketing information 120 is printed on the sheet 112 with solvent/UV based ink jet media. In other embodiments, the ink jet media may be water based. In other embodiments, the marketing information may be printed with any suitable types of inks and/or pigments. In alternate embodiments, the marketing information is integrally formed with the polymeric sheet 112. For example, a logo or trademark may be formed in the polymeric sheet 112 during manufacture. In other embodiments, the marketing information may be printed onto a separate sheet, film or material, that is then applied to the polymeric sheet 112 using any suitable adhesive.

As shown in FIG. 6, the EL lamp 150 is first appropriately attached to the rear of polymeric sheet 112. A pressure sensitive adhesive material 115 is applied to the bottom surface 114 of the polymeric sheet 112. A second, removeable, peel-off liner or film 116 is applied and protects the adhesive material 115 prior to its emplacement on the mattress 140. The second film or liner 116 is removable and is discarded upon removal from the display pad 110.

The adhesive material 115 releasably attaches the display pad 110 to the mattress 140. In a preferred embodiment, the adhesive material 115 is permanently affixed to the polymeric sheet 112 while allowing for the releasable attachment of the display pad 110 to the rear layer 60 of EL lamp 150. The adhesive material is selected to prevent damage, e.g., marring of the fabric or pattern, abrasion, etc., to the foot protector 130, which might otherwise occur when removing an adhesive from the foot protector 130.

The adhesive material is a chemical, polymer, copolymer, polymer or co-polymer blend, a composition, resin, or any combination thereof, that forms a temporary bond with the foot protector. An exemplary adhesive material is an acrylic pressure sensitive adhesive. As used herein, a “pressure sensitive adhesive” refers to an adhesive that forms a temporary bond upon the application of pressure. In other alternate embodiments, however, a non-pressure sensitive adhesive is used.

The adhesive material may be a natural or synthetic adhesive. Exemplary natural adhesives include, but are not limited to, starch, animal or vegetable resins. Exemplary synthetic adhesives include, but are not limited to, acrylic and/or other acrylate based adhesives, rubber based adhesives, polyvinyl acetate, epoxy, or polyurethane. In a preferred embodiment, the adhesive material is acrylic based.

The adhesive material 115 is applied to the rear surface of EL lamp 150 with a liquid carrier, or in solid form. Preferably the adhesive material is a liquid carrier or solvent based adhesive. For liquid carrier adhesives, the adhesive is coated onto the polymeric sheet 112, and the solvent, or water carrier is dried off. Additional heat may be applied to the adhesive and EL lamp 150 to initiate a cross-linking reaction and increase molecular weight of the adhesive. The solid adhesives may be low viscosity polymers. The solid adhesive materials are also coated onto the EL lamp 150 and reacted with radiation to increase molecular weight and form the adhesive thereon. In other embodiments, the solid-type adhesives may be high viscosity materials that are heated to reduce viscosity enough to allow coating, and then cooled to their final form.

The EL lamp 150 is used with display pad 110 and foot protector 130 in generally the same manner as described with respect to the embodiment illustrated in FIG. 1-4.

### EXAMPLE A

In one example of the invention, the removable display pad 110 includes a polyvinyl chloride sheet 112 with an acrylic based, pressure sensitive adhesive 115 applied thereto. A peel off liner 116 is included on the adhesive material, and is discarded prior to application on the mattress. An exemplary product is product no. JTS828 HTO, available under the Mac Tact brand (A Bemis Company). This product is a 3.7 mil matte white, soft calendared PVC film coated on one side with a high tack, permanent, opaque, solvent acrylic pressure sensitive adhesive, supplied with a Kraft liner. Marketing information may be printed thereon using solvent-based ink jet printing media. A vinyl overlaminate, such as Print Shield® SEAL®, available from Neschen Americas, Inc, is used to protect the marketing information.

### EXAMPLE B

In another example of the invention, the removable display pad 110 includes a polyvinyl chloride sheet 112 with an acrylic based, pressure sensitive adhesive 115 applied thereto as described above. The removable display pad is placed on a fabric foot protector, for example, Style 12081 Foot Protector with Flange and polyester backing, available from Wright Graphics.

Although the present invention has been described with exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

What is claimed is:

1. A showroom display device for utilization in association with a mattress on display in a mattress showroom, the showroom display presenting product information regarding the mattress, the display device comprising:
a display panel of such size and shape as to cover at least a portion of a surface of the mattress;
the display panel having marketing information visible on the surface thereof;
and the display panel further including an electroluminescent lamp associated therewith, the electroluminescent lamp connectable to a power source and program controller and so associated therewith so as to highlight/enhance various areas of the display panel according to a prescribed program.

2. The display device according to claim 1 further comprising a mattress foot protector, wherein the display panel is arranged thereon.

3. The display device according to claim 2 wherein the electroluminescent lamp is further connected to a programmer for activating the lamp in a pattern according to the prescribed program.

4. The display device according to claim 2 wherein the electroluminescent lamp comprises a plurality of ink layers in which:
a first ink layer is a translucent conductive ink which includes a conductive material and forms a first electrode;
a second ink layer adjacent the first layer is a phosphor containing ink that emits light when a current is driven through it;
a third ink layer adjacent the second layer includes a dielectric material which acts as a capacitor;
a fourth ink layer adjacent the third layer is a conductive opaque ink which includes a conductive material and serves as the second electrode;
a fifth ink layer which includes a screen printable, UV cure material and serves as an incapsulent printed as the outermost layer;
the first and fourth layers being connected to a power source which, when activated, generates a current through the second phosphor containing layer causing the phosphor to emit light.

5. The display device according to claim 4 wherein the electroluminescent lamp further includes a programmer for activating and deactivating the lamp according to the prescribed program.

6. The display device according to claim 4 wherein the first layer is divided into discrete segments, each being separately connected to the power source and activated by the programmer to emit light from the various segments at various times according to the prescribed program.

7. The display device according to claim 2 and further presenting selectively changeable product information regarding the mattress and comprising:
the display panel including an area of programmable light emitting units for presenting the selectively changeable visual product information regarding the mattress; and
the display panel having the capability to connect to a power source and a programmable product information control source.

8. The display device of claim 7, wherein the display panel is formed of one or more layers of fabric.

9. The display device of claim 8, wherein the display panel is embedded in the one or more layers of fabric.

10. The display device of claim 7, wherein the area of programmable light emitting units comprises light emitting diodes.

11. The display device of claim 7, wherein the area of programmable light emitting units comprises electroluminescent pixels or electroluminescent pixel arrays.

12. The display device of claim 7, wherein the area of programmable light emitting units comprises organic light emitting diodes.

13. The mattress showroom display device of claim 10, wherein the light emitting diodes are associated with a laminated flexible plastic panel.

14. The display device according to claim 2, wherein the panel is releasably attached to the foot protector, the removable display panel also protecting the mattress from customer soiling, wear and damage when testing the mattress in the showroom and comprising:
a. a polymeric sheet of such size and shape as to, when applied to the foot protector on the mattress, substantially covers the portion of the foot protector on the upper surface of the mattress, the sheet having a top surface and an undersurface;
b. an adhesive material on the undersurface of the sheet, the adhesive being releasably attachable to the surface of the foot protector without marring the surface thereof

15. The removable display pad of claim 14, wherein the adhesive material is a pressure sensitive adhesive.

16. The removable display pad of claim 14, further comprising a transparent film affixed to the top surface of the polymeric sheet to protect the marketing information thereon.

17. The removable display pad of claim 14, wherein the polymeric sheet is selected from the group consisting of a polyvinyl chloride, polyethylene, polypropylene, and polyethylene terepthalate.

18. The removable display pad of claim 14, further comprising a removable liner on the adhesive material.
